(19) United States
(12) Patent Application Publication
(10) Pub. No.: US 2007/0052999 A1
(43) Pub. Date: Mar. 8, 2007

(54) Image processing apparatus and image processing system

(75) Inventor: Toshiyuki Nakade, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/477,199

(22) Filed: Jun. 28, 2006

(30) Foreign Application Priority Data
Jul. 6, 2005 (JP) 2005-197020

(51) Int. Cl. G06F 3/12

(52) U.S. Cl. 358/1.15; 358/401

(57) ABSTRACT

Disclosed is an image processing apparatus, which comprises a control section operable, when a communication-possibility determination section determines that it is impossible to communicate with a server apparatus, to store and keep processed sheet number information representing the number of image-processed sheets in a sheet-number storage section in correspondence with user-identification information for identifying each user, and when the communicate with the server apparatus is determined to be possible, to transmit the processed-sheet-number information stored in the sheet-number storage, to the server apparatus in correspondence with the user-identification information. The image processing apparatus makes it possible to reliably manage an accumulated sheet number on the side of the server apparatus, on a user-by-used basis.

### BACKGROUND OF THE INVENTION

1. Field of the Invention

The present invention relates to an image processing apparatus communicatably connected to a server apparatus for managing, on a user-by-user basis, an accumulated sheet number which is an accumulated value of the number of image-processed sheets, and an image processing system.

2. Description of the Related Art

Along with the popularization of an image processing apparatus, such as a copy machine, there are increasing cases where a plurality of image processing apparatuses are set up on one floor. In such cases, for the purpose of accounting or the like, it has been proposed a technique of managing, on a user-by-user basis, an accumulated sheet number which is an accumulated value of the number of image-processed sheets (e.g. the number of copied sheets, in a copy machine). For example, the proposed technique includes a system for managing an accumulated value of the number of copied sheets on a user-by-user basis using a server apparatus communicatably connected to an image processing apparatus (see the following Patent Publication 1). In this system, a result or record of the image processing executed by the image processing apparatus (user-identification information, the number of processed sheets, etc.) is transmitted to the server apparatus, and an accumulated sheet number which is an accumulated value of the number of image-processed sheets is managed by the server apparatus, on a user-by-user basis.

[Patent Publication 1] Japanese Patent Laid-Open Publication No. 2001-297045

However, if the image processing apparatus temporarily becomes impossible to communicate with the server apparatus, the above system will be faced with a problem of difficulty in accurately managing an accumulated value of the number of copied sheets per user.

### SUMMARY OF THE INVENTION

It is an object of the present invention to provide an image processing apparatus and an image processing system which can accurately process an accumulated sheet number on a user-by-user basis.

The present invention provides an image processing apparatus communicatably connected to a server apparatus for managing an accumulated sheet number which is an accumulated value of the number of image-processed sheets, and adapted to execute a given image processing. This image processing apparatus comprises: a user entry accepter for accepting user-identification information for identifying each user; a sheet-number storage adapted to store processed-sheet-number information representing the number of image-processed sheets, in correspondence with the user-identification information; a sheet-number processor for allowing the processed-sheet-number information to be stored in the sheet-number storage in correspondence with the user-identification information; a communication determinator for determining whether it is possible to communicate with the server apparatus; and a sheet-number transmitter operable, when the communication with the server apparatus is determined to be possible, to transmit the processed-sheet-number information stored in the sheet-number storage, to the server apparatus in correspondence with the user-identification information.

In the image processing apparatus of the present invention, the user entry accepter is operable to accept the user-identification information for identifying each user, and the communication determinator is operable to determine whether it is possible to communicate with the server apparatus. Further, the sheet-number processor is operable to store the processed-sheet-number information representing the number of image-processed sheets in the sheet-number storage in correspondence with the user-identification information.

It may be, for example, appreciated that the sheet-number transmitter is operable, when the communication with the server apparatus is determined to be impossible, to allow the processed-sheet-number information to be kept in the state of being stored in the sheet-number storage in correspondence with the user-identification information, and, when the communication with the server apparatus is determined to be possible, to transmit the processed-sheet-number information stored in the sheet-number storage, to the server apparatus in correspondence with the user-identification information.

When the communication with the server apparatus is determined to be impossible, for example, temporarily, the processed-sheet-number information is stored in the sheet-number storage in correspondence with the user-identification information. Thus, processed-sheet-number information generated during a period where it is impossible to communicate with the server apparatus is stored in the sheet-number storage in correspondence with the user-identification information. Then, when a communication function is recovered and the communication with the server apparatus is determined to be possible, the processed-sheet-number information stored in the sheet-number storage is transmitted to the server apparatus in correspondence with the user-identification information. Thus, the processed-sheet-number information generated during a period where it is impossible to communicate with the server apparatus will become usable in the server apparatus after recovery of the communication function. This makes it possible to reliably manage the accumulated sheet number which is an accumulated value of the number of image-processed sheets, on a user-by-used basis.

### BRIEF DESCRIPTION OF THE DRAWINGS

FIG. 1 is a block diagram showing an image processing system according to one embodiment of the present invention.

FIG. 2 is a block diagram showing the configuration of a complex machine in the image processing system.

FIG. 3 is a functional block diagram showing a control section of the complex machine.

FIG. 4 is a functional block diagram showing a control section of a server apparatus in the image processing system.

FIG. 5 is a chart showing one example of an information block stored in a sheet-number storage section illustrated in FIG. 3.

FIG. 6 is an explanatory flowchart showing an operation of the control section of the complex machine.

FIG. 7 is a detailed flowchart showing a sheet-number acquisition operation to be performed in Step S105 in the flowchart illustrated in FIG. 6.

FIG. 8A is a detailed flowchart showing a sheet-number renew operation to be performed in Step S123 in the flowchart illustrated in FIG. 6.

FIG. 8B is a chart showing a classification of image processing.

FIG. 9 is a detailed flowchart showing a sheet-number transmission operation to be performed in Step S127 in the flowchart illustrated in FIG. 6.

### DETAILED DESCRIPTION OF THE PREFERRED EMBODIMENTS

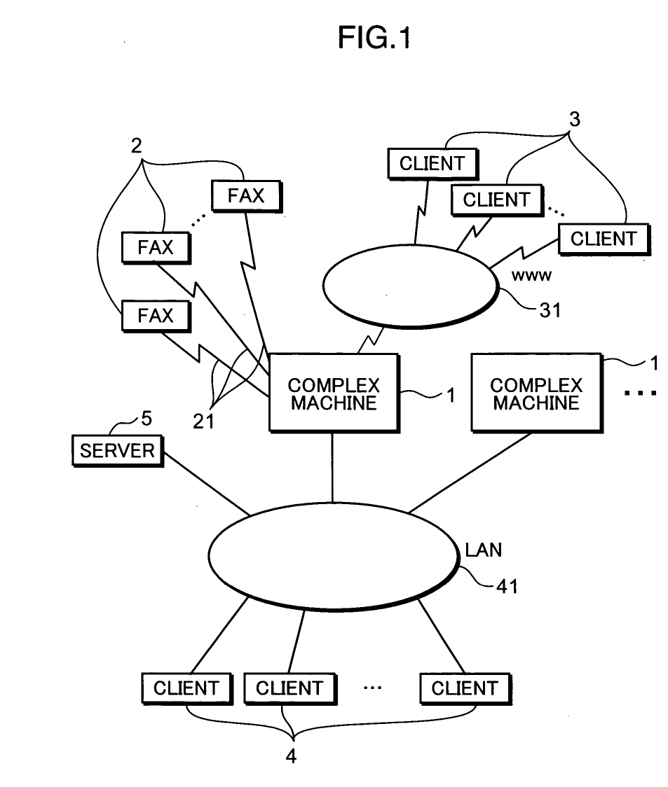

FIG. 1 is a block diagram showing an image processing system according to one embodiment of the present invention.

In this embodiment, an image processing apparatus forming a part of the image processing system is a complex machine having functions of a copy machine, a scanner, a facsimile machine, an Internet facsimile machine and a network printer.

A server apparatus 5 is communicatably connected to a plurality of the complex machines 1 via a LAN (Local Area Network) 41. Each of the complex machines 1 is communicatably connected to a plurality of facsimile machines 2 via a public telephone line 21. Further, the complex machine 1 is communicatably connected to a plurality of client terminal units 3 via the Internet (WWW) 31. The complex machine 1 is also communicatably connected to a plurality of client terminal units 4 via the LAN 41.

The server apparatus 5 serves as a means for managing, on a user-by-user basis, an accumulated sheet number which is an accumulated value of the number of image-processed sheets, i.e. the number of sheets which have been subjected to an image processing (to be executed according to either one of the functions of a copy machine, a scanner, a facsimile machine, an Internet facsimile machine and a network printer) of the complex machine 1 (for example, the number of copied sheets when the complex machine 1 serves as a copy machine).

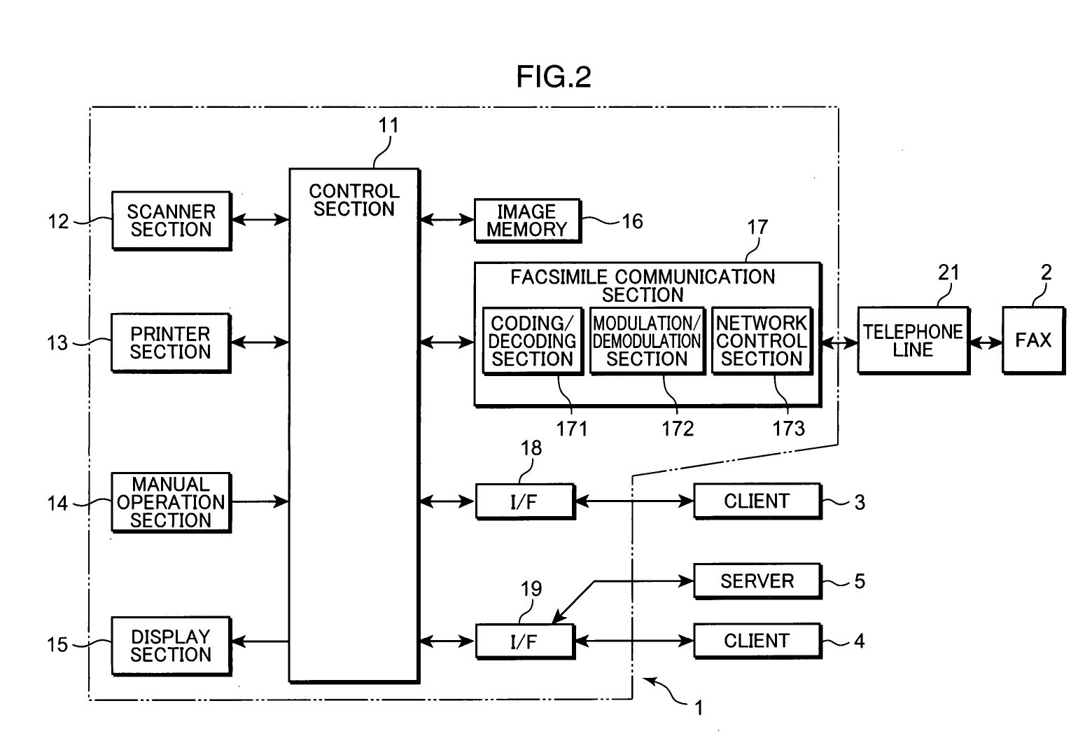

When the complex machine 1 serves as a scanner, the complex machine 1 is operable to read an image from a document with the image formed thereon, using an after-mentioned scanner section 12 (see FIG. 2) so as to create image data, and transmit the created image data to the client terminal unit 4 via an after-mentioned interface section 19 (see FIG. 2) and the LAN 41.

When the complex machine 1 serves as a facsimile machine, the complex machine 1 is operable to transmit and receive image data to/from a facsimile machine 2 as the other end, via the public telephone line 21. In an operation for transmitting image data, the complex machine 1 is operable to read image data of a document from the scanner section 12, and transmit image data of each document page to the facsimile machine 2 via the public telephone line 21. In an operation for receiving image data, the complex machine 1 is operable to receive image data of each document page from the facsimile machine 2 via an after-mentioned facsimile communication section (see FIG. 2) and the public telephone line 21, and form an image on a recording sheet using an after-mentioned printer section 13 (see FIG. 2).

When the complex machine 1 serves as an Internet facsimile machine, the complex machine 1 is operable to transmit and receive image data to/from each of the client terminal units 3 via the Internet. In an operation for transmitting image data, the complex machine 1 is operable to read image data of a document from the scanner section 12, and transmit image data of each document page to the client terminal unit 3 via the Internet 31. In an operation for receiving image data, the complex machine 1 is operable to receive image data of each document page from the client terminal unit 3 via the an after-mentioned interface section 18 (see FIG. 2) and the Internet 31, and form an image on a recording sheet using the printer section 13.

When the complex machine 1 serves as a facsimile machine, the complex machine 1 is operable to transmit and receive image data to/from each of the facsimile machines 2 as the other end, via the public telephone line 21. In an operation for transmitting image data, the complex machine 1 is operable to read image data of a document from the scanner section 12, and transmit image data of each document page to the facsimile machine 2 via the public telephone line 21. In an operation for receiving image data, the complex machine 1 is operable to receive image data of each document page from the facsimile machine 2 via an after-mentioned facsimile communication section 17 (see FIG. 2) and the public telephone line 21, and form an image on a recording sheet using an after-mentioned printer section 13 (see FIG. 2).

When the complex machine 1 serves as a network printer, the complex machine 1 is operable to receive image data of each document page from each of the client terminal units 4 via the LAN 41 and the interface section 19 (see FIG. 2), and form an image on a recording sheet using the printer section 13 (see FIG. 2). When the complex machine 1 serves as a copy machine, the complex machine 1 is operable to read image data of a document from the scanner section 12 (see FIG. 2), and form an image on a recording sheet using the printer section 13 (see FIG. 2).

FIG. 2 is a block diagram showing the configuration of the complex machine 1. The complex machine 1 comprises a control section 11 for controlling an operation of the entire complex machine 1, a scanner section 12 for reading a document image to create image data, a printer section 13 for transferring an image from the image data onto a recording sheet, a manual operation section 14 composed of a touch panel or the like and adapted to accept an manual operation of a user, a display section 15 composed of a LCD (Liquid Crystal Display) or the like and adapted to display guidance information for the manual operation, an image memory 16 for storing image data thereon, and a facsimile communication section 17 for performing an image data processing for transmission/receiving to/from the facsimile machine 2. An interface section 18 is provided as a means for performing an image data processing for transmission/receiving to/from the client terminal unit 3. An interface section 19 is provided as a means for performing an image data processing for transmission/receiving to/from the client terminal unit 4.

The control section 11 includes a CPU (Central Processing Unit), a ROM (Read Only Memory) for storing a control program, information about various images to be displayed on the display section 14, etc., and a RAM (Random Access Memory) for temporarily storing processed data. The control section 11 is designed to accept information about user's manual operation from the manual operation section 14 so as to control an operation of the entire complex machine 1.

The scanner section 12 is provided as a means for scanning a document placed on a document mounting portion (not shown), converting each scanned line into an image signal on a pixel-by-pixel basis, subjecting the image signal to a given signal processing (level correction, y-correction, A/D conversion, etc.), and outputting the processed signal to the control section 11, so as to carry out a scammer function.

The printer section 13 is provided as a means for printing out image data onto a recording sheet so as to carry out a printer (or copy) function. For example, the printer section 13 is composed of a laser printer, which is designed to emit a laser beam modulated with image data, onto a photosensitive member to form thereon a latent image of an image consisting of the image data, and, after electrostatically attaching toner onto the latent image so as to visualize the latent image, transfer the visualized image onto a recording sheet so as to form an image on the recording sheet.

The manual operation section 14 is composed, for example, of a numeric keypad or a touch panel. This touch panel may be a conventional type. For example, the touch panel may comprise a rectangular-shaped thin-layer body having a plurality of pressure-sensitive elements made of a linear transparent material and arranged thereon vertically and horizontally at given pitches, and a transparent cover cornering over the thin-layer body. In this case, this touch panel is attached onto a top surface of the display section 15. The display section 15 may be designed to display a plurality of selection buttons for prompting a user to make a selection, on a screen thereof. Thus, when the user presses or designates one of the selection buttons, the designated button can be detected based on an address of the touch panel corresponding to the pressed position.

The display section 15 comprises a LCD and a LED (Light-Emitting Diode). The display section 15 is designed to display various states, such as a state of connection with the public telephone line 21 and a state of transmission/receiving of image information, and information about a destination of image data (FAX. No.), on the LCD in the form of textual and/or image information. The display section 15 is also designed to display various alerts, such as the presence of a communication error and the necessity of maintenance, on the LCD.

The image memory 16 is provided as a means for storing image data and other data. For example, the image memory 16 is composed of a large-capacity memory capable of storing image data corresponding to a given number (e.g. about 100) of A-4 size standard documents.

The facsimile communication section 17 is provided as a means for performing an image data processing for transmission/receiving to/from the facsimile machine 2 via the public telephone line 21 when the complex machine 1 serves as a facsimile machine. The facsimile communication section 17 comprises a coding/decoding section 171, a modulation/demodulation section 172 and a network control section 173. The coding/decoding section 171 is operable to compress and coded image data to be transmitted, and expand and decode received image data. The modulation/demodulation section 172 is operable to modulate the compressed/coded image data to an audio signal, and demodulate the received signal (audio signal) to image signal. The network control section 173 is equivalent to a NCU (Network Control Unit), and operable to control a connection of the public telephone line 21 for communication with the facsimile 2 as the other end.

The interface section 18 is operable to perform an image data processing for transmission/receiving to/from the client terminal unit 3 when the complex machine 1 serves as an Internet facsimile machine. The interface section 19 is operable to perform an image data processing for transmission/receiving to/from the client terminal unit 4 when the complex machine 1 serves as a network printer.

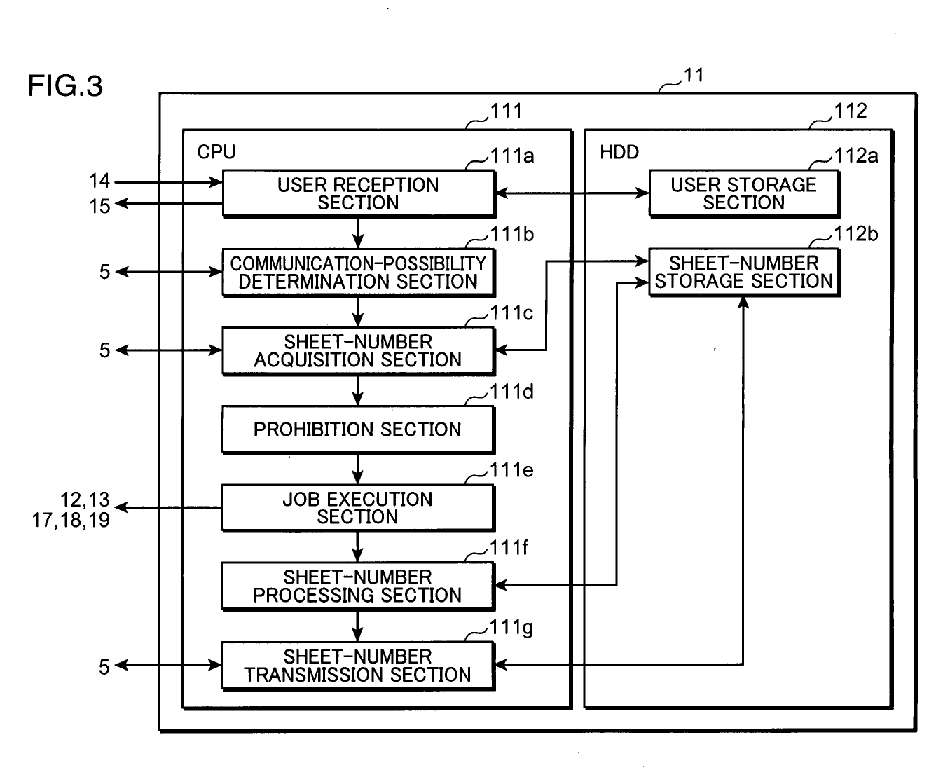

FIG. 3 is a functional block diagram showing the control section 11. The controller comprises a CPU 111 which functionally includes: a user entry section 111a (serving as user entry accepter) for accepting user-identification information (a user ID, in this embodiment); a communication-possibility determination section 111b (serving as communication determinator) for determining whether it is possible to communicate with the server apparatus 5; a sheet-number acquisition section 111c (serving as sheet-number acquisitor) for acquiring accumulated sheet number information corresponding to the user ID from the server apparatus 5; a prohibition section 111d (serving as prohibitor) for prohibiting an after-mentioned job execution section 111e from executing an image processing when an after-mentioned given condition is satisfied; a job execution section 111e (serving as processing acceptor) for accepting an instruction for an execution of an image processing and executing the corresponding image processing; a sheet-number processing section 111f (serving as sheet-number processor) for allowing processed-sheet-number information to be stored in an after-mentioned sheet-number storage section 112b in correspondence with the user ID; and a sheet-number transmission section 111g (serving as sheet-number transmitter) for transmitting the processed-sheet-number information stored in the sheet-number storage section 112b, to the server apparatus 5 in correspondence with the user ID.

The control section 11 also includes HDD 112 which functionally has a user storage section 112a for storing information about registered users, and a sheet-number storage section 112b for storing the processed-sheet-number information in correspondence with the user ID.

In this embodiment, the CPU 111 is operable to read a control program stored on a ROM or the like and execute the program so as to serve as a functional section including the user entry section 111a, the communication-possibility determination section 111b, the sheet-number acquisition section 111c, the prohibition section 111d, the job execution section 111e, the sheet-number processing section 111f, the sheet-number transmission section 111g, the user storage section 112a and the sheet-number storage section 112b.

Among various data stored on the HDD 112 and ROM, data capable of being stored on a detachable recording medium may be read, for example, by an optical disk drive, a flexible disk drive, a silicon disk drive or a cassette-medium reader. In this case, the recording medium may be an optical disk, a flexible disk, a CD, a DVD or a semiconductor memory.

The user entry section 111a is operable to accept a user ID through the manual operation section 14 and the display section 15, and determine whether the entered user ID is identical to one of registered user IDs of the registered users stored in the user storage section 112a.

The communication-possibility determination section 111b is operable to transmit a ping (packet Internet grouper) to the server apparatus 5 so as to determine whether it is possible to communicate with the server apparatus 5, based on the resulting response.

The sheet-number acquisition section 111c is operable, when the communication-possibility determination section 111b determines that it is possible to communicate with the server apparatus 5, to acquire accumulated sheet-number information corresponding to the user ID entered through the user entry section 111a, from the server apparatus 5, and store the acquired accumulated sheet-number information in the sheet-number storage section 112b in correspondence with the user ID.

Further, the sheet-number acquisition section 111c is operable, when the communication-possibility determination section 111b determines that it is impossible to communicate with the server apparatus 5, to acquire per-user upper-limit sheet-number information representing an upper limit value of the accumulated sheet number which is pre-set with respect to each user ID as the basis for permitting an execution of an image processing, and store the acquired per-user upper-limit sheet-number information in the sheet-number storage section 112b in correspondence with the user ID.

For example, if the per-user upper-limit sheet-number information is set (renewed) every month, the sheet-number acquisition section 111c may automatically acquire the per-user upper-limit sheet-number information only once every given time-period, preferably at a given date (e.g. at 0.00 AM on the 1st day) in each month, using a built-in calendar function, or may acquire the per-user upper-limit sheet-number information only once every given time-period through a manual setting.

The prohibition section 111d is operable to determine whether a sum of the accumulated sheet number stored in the sheet-number storage section 112b and a designated sheet number accepted by the job execution section 111e in this embodiment is greater than a predetermined upper-limit sheet number, and, when the sum is determined to be greater than the upper-limit sheet number, to prohibit an execution of the image processing accepted by the job execution section 111e. In this embodiment, the predetermined upper-limit sheet number is the per-user upper-limit sheet number acquired by the sheet-number acquisition section 111c, which corresponds to the user ID entered through the user entry section 111a.

Further, the prohibition section 111d is operable, when none of the per-user upper-limit sheet number and the accumulated sheet number corresponding to the user ID entered through the user entry section 111a is stored in the sheet-number storage section 112b, to prohibit an execution of the image processing accepted by the job execution section 111e.

The job execution section 111e is operable to accept an instruction for an execution of an image processing, which includes a designated sheet number, i.e. a designated number of sheets to be image-processed, and execute the designated image processing. If an execution of the image processing is prohibited by the prohibition section 111d, the job execution section 111e will cancel an execution of the image processing.

For example, when the complex machine 1 serves as a copy machine, the job execution section 111e is operable to accept an instruction for an execution of a specific image processing (copying, in this case), through the manual operation section 14. When the complex machine 1 serves as a network printer, the job execution section 111e will accept an instruction for an execution of a specific image processing (printing, in this case), from the client terminal unit 4 through the LAN 41 and the interface section 19.

The sheet-number processing section 111f is operable to allow processed-sheet-number information representing the number of sheets image-processed by the job execution section 111e, to be stored in the sheet-number storage section 112b in correspondence with the user ID entered through the user entry section 111a.

The sheet-number processing section 111f is also operable to store a sum of the accumulated sheet number stored in the sheet-number storage section 112b and processed-sheet-number information representing the number of sheets image-processed by the job execution section 111e, in the sheet-number storage section 112b as a new accumulated sheet number (i.e. renew the accumulated sheet number).

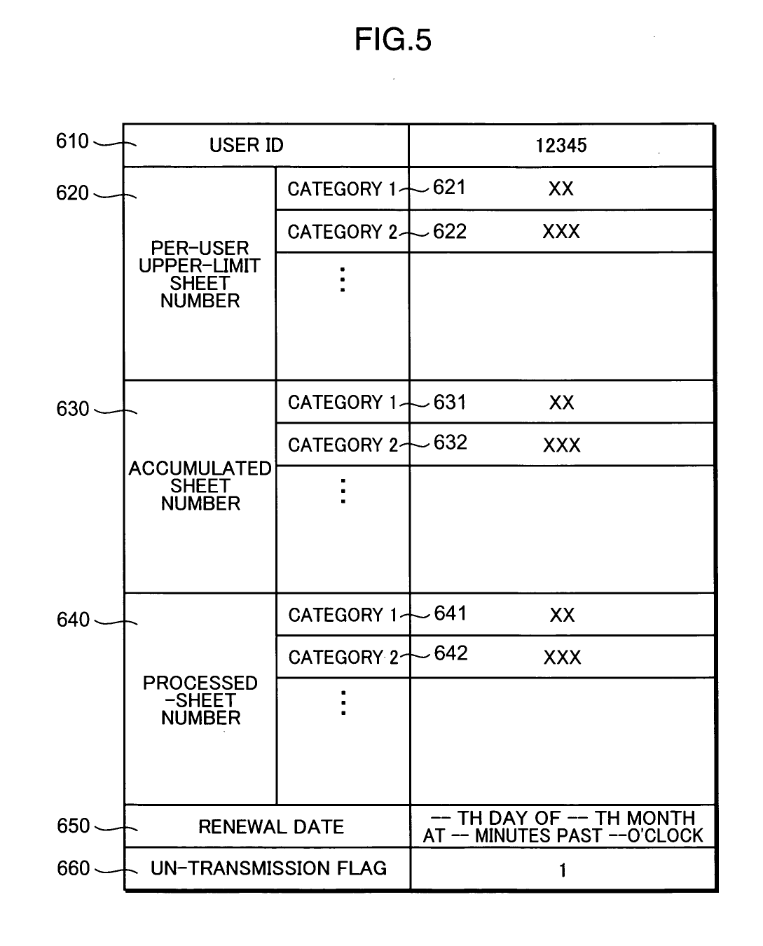

The sheet-number transmission section 111g is operable, only when the communication-possibility determination section 111b determines that it is possible to communicate with the server apparatus 5, to transmit the processed-sheet-number information stored in the sheet-number storage section 112b, to the server apparatus 5 in correspondence with the user ID, and, when the transmitted processed-sheet-number information is received by the server apparatus 5, to reset the processed-sheet-number information in the sheet-number storage section 112b to a zero value. The sheet-number storage section 112b is operable to store the processed-sheet-number information obtained by the sheet-number processing section 111f, the accumulated sheet number information obtained by the sheet-number processing section 111f, and the per-user upper-limit sheet-number information acquired by the sheet-number acquisition section 111c, in correspondence with the user ID (see FIG. 5).

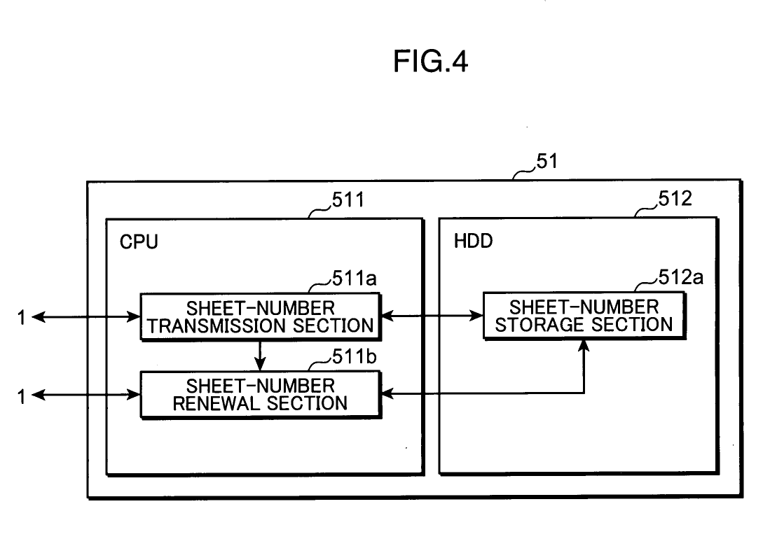

FIG. 4 is a functional block diagram showing a control section of the server apparatus 5. The control section 51 of the server apparatus 5 comprises a CPU 511 which functionally includes a sheet-number transmission section 511a operable, in response to a request from the complex machine 1, to transmit accumulated sheet number information and per-user upper-limit sheet number information corresponding to a received user ID, to the complex machine 1, and a sheet-number renewal section 511b operable, in response to receiving a user ID and processed-sheet-number information from the complex machine 1, to renew accumulated sheet number corresponding to the received user ID, which is currently stored in an after-mentioned sheet-number storage section 512a, to a sum of the received processed-sheet-number and the current accumulated sheet number.

Further, the control section 51 includes a HDD 512 which functionally has a sheet-number storage section 512a for storing accumulated sheet number information and per-user upper-limit sheet number information, in correspondence with each user ID.

In this embodiment, the CPU 511 is operable to read a control program stored on a ROM or the like and execute the program so as to serve as a functional section including the sheet-number transmission section 511a, the sheet-number renewal section 511b and the sheet-number storage section 512a.

Among various data stored on the HDD 512 and ROM, data capable of being stored on a detachable recording medium may be read, for example, by an optical disk drive, a flexible disk drive, a silicon disk drive or a cassette-medium reader. In this case, the recording medium may be an optical disk, a flexible disk, a CD, a DVD or a semiconductor memory.

The sheet-number transmission section 511a is operable, in response to a request from the complex machine 1 (specifically, from the sheet-number acquisition section 111c illustrated in FIG. 3), to read the accumulated sheet number information and the per-user upper-limit sheet number information corresponding to a user ID included in the request, from the sheet-number storage section 512a, and transmit them to the complex machine 1.

The sheet-number renewal section 511b is operable, in response to receiving a user ID and processed-sheet-number information from the complex machine 1 (specifically, from the sheet-number transmission section 11g illustrated in FIG. 3), to renew the accumulated sheet number corresponding to the received user ID, which is currently stored in the sheet-number storage section 512a, to a sum of the received processed-sheet-number and the current accumulated sheet number. The sheet-number storage section 512a is operable to store the accumulated sheet number information and the per-user upper-limit sheet number information in correspondence with each user ID.

FIG. 5 is a chart showing one example of an information block stored in the sheet-number storage section 112b illustrated in FIG. 3. As shown in FIG. 5, a per-user upper-limit sheet number 620 which is an upper limit value of the accumulated sheet number as the basis for permitting an execution of an image processing, an accumulated sheet number 630 which is an accumulated value of the number of image-processed sheets, a processed sheet number 640 which is the number of image-processed sheets, an renew data 650 which is a last renewal date of the processed sheet number 640, and an un-transmission flag 660 which is a flag indicative of whether the processed sheet number 640 has been transmitted to the server apparatus 5, are stored in the sheet-number storage section 112b in correspondence with a specific user ID 610.

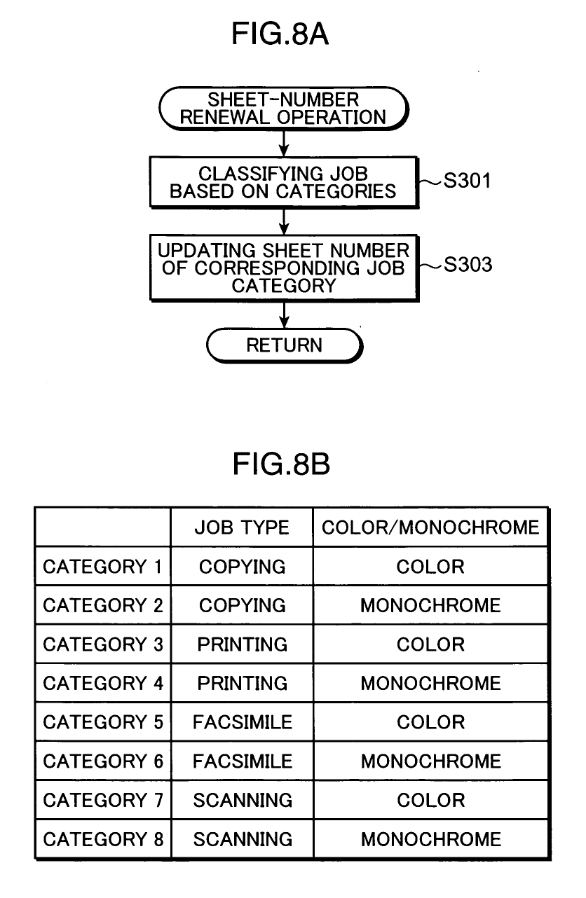

Among them, each of the per-user upper-limit sheet number 620 and the processed sheet number 640 is classified into one of a plurality (eight, in this embodiment) of categories as described later with reference to FIG. 8B. The un-transmission flag 660 is set to “1” (turned on) when the processed sheet number 640 is stored in the sheet-number storage section 112b by the sheet-number processing section 111f, and set to “0” (turned off) when the processed sheet number 640 and the accumulated sheet number 630 are transmitted to the server apparatus 5. That is, the un-transmission flag 660 identifies data to be transmitted to the server apparatus 5.

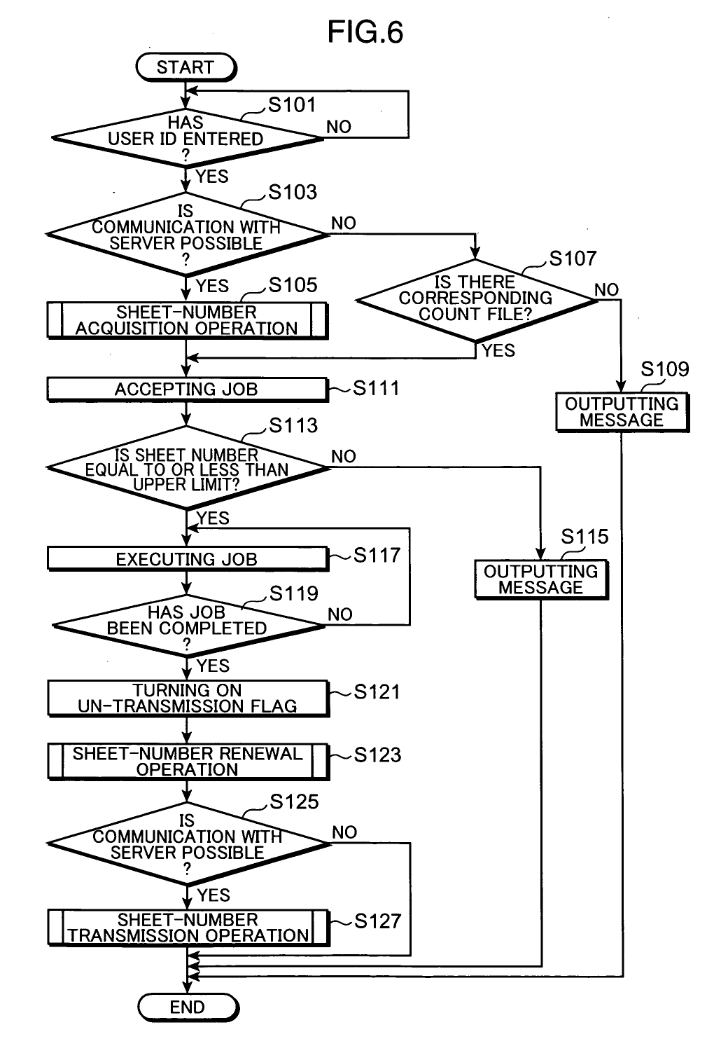

FIG. 6 is an explanatory flowchart showing an operation of the control section 11. Firstly, the user entry section 111a determines whether a user ID of one of the registered users is entered (Step S101). If it is determined that no user ID of the registered users is entered (NO in Step S101), the process will be kept in a standby state. When it is determined that a user ID of one of the registered users is entered (YES in Step S101), the communication-possibility determination section 111b determines whether it is possible to communicate with the server apparatus 5 (Step S103).

When the communication is determined to be possible (YES in Step S103), the sheet-number acquisition section 111c acquires accumulated sheet number information and per-user upper-limit sheet-number information corresponding to the user ID entered in Step S101, and stores the accumulated sheet number information and the per-user upper-limit sheet-number information in the sheet-number storage section 112b in correspondence with the user ID (Step S105).

If the communication is determined to be impossible (NO in Step S103), the prohibition section 111d will determine whether the accumulated sheet number information and the per-user upper-limit sheet-number information corresponding to the user ID entered in Step S101 are stored in the sheet-number storage section 112b (Step S107). If it is determined that the information is not stored, the prohibition section 111d will display a message informing that an execution of an image processing is prohibited because none of the accumulated sheet number information and the per-user upper-limit sheet-number information corresponding to the user ID entered in Step S101 is stored in the sheet-number storage section 112b (Step S109), and the process will be terminated.

After the operation in Step S105 is completed or when the determination in Step 107 is YES, the job execution section 111e accepts an instruction of an image processing (hereinafter referred to as “job”) including a designated sheet number, i.e. a designated number of sheets to be subjected to the job (Step S111). Then, the prohibition section 111d determines whether a sum of the accumulated sheet number stored in the sheet-number storage section 112b and the designated sheet number accepted by the job execution section 111e is equal to or less than the per-user upper-limit sheet number (Step S113).

If it is determined that the sum is greater than the per-user upper-limit sheet number (NO in Step S113), the prohibition section 111d will display a message informing that an execution of an image processing is prohibited because the designated sheet number will cause deviation from the per-user upper-limit sheet number (Step S115), and the process will be terminated.

When it is determined that the sum is equal to or less than the per-user upper-limit sheet number (YES in Step S113), the job execution section 111e executes the job accepted in Step S111 (Step S117).

Then, the job execution section 111e determines whether the job has been completed (Step S119). If it is determined that the job has not been completed (NO in Step S119), the process will return to Step S117 to continue the job. When it is determined that the job has been completed (YES in Step S119), a processed sheet number is stored in the sheet-number storage section 112b, and the n-transmission flag is turned on (Step S121). Then, the sheet-number processing section 111f stores a sum of the accumulated sheet number stored in the sheet-number storage section 112b and the processed sheet number which is the number of sheets image-processed in Step S117, in the sheet-number storage section 112b as a new accumulated sheet number (i.e. the accumulated sheet number is renewed) (Step S123).

Then, the communication-possibility determination section 111b determines whether it is possible to communicate with the server apparatus 5 (Step S125). If the communication with the server apparatus 5 is determined to be impossible (NO in Step S125), the process will be terminated. Specifically, the renewed accumulated sheet number stored in the sheet-number storage section 112b will be maintained. When the communication with the server apparatus 5 is determined to be possible (YES in Step S125), the sheet-number transmission section 111g transmits the processed-sheet-number information and the accumulated sheet number information stored in the sheet-number storage section 112b, to the server apparatus in correspondence with the user ID (Step S 127), and the process is terminated.

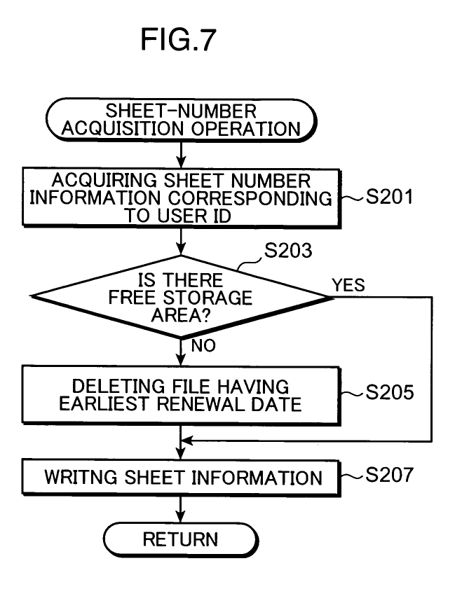

FIG. 7 is a detailed flowchart showing the sheet-number acquisition operation to be executed in Step S105 in the flowchart illustrated in FIG. 6. The following operation is entirely performed by the sheet-number acquisition section 111c. Firstly, the accumulated sheet number information and the per-user upper-limit sheet number information corresponding to the user ID entered in Step S101 of FIG. 6 are acquired from the server apparatus 5 (Step S201). Then, it is determined whether a free area enough to store the information for one user as shown in FIG. 5 exists in the sheet-number storage section 112b (Step S203).

When it is determined that the free space exists (YES in Step S203), the process advances to Step S207. If it is determined that no free space exists (NO in Step S203), one of a plurality of information blocks as shown in FIG. 5, which has the earliest renewal date 650, will be deleted (Step S205). Then, after the operation in Step S205 is completed or when the determination in Step S3 is YES, the accumulated sheet number information and the per-user upper-limit sheet number information corresponding to the user ID entered in Step S101 of FIG. 6 is written in the sheet-number storage section 112b (Step S207), and the sheet-number acquisition operation is completed.

FIG. 8A is a detailed flowchart showing the sheet-number renew operation to be executed in Step S123 in the flowchart illustrated in FIG. 6, and FIG. 8B is a chart showing a category of image processing. The entire operation illustrated in FIG. 8A is performed by the sheet-number processing section 111f.

As shown in FIG. 8B, the image processing is classified by eight categories 1 to 8. Each of the accumulated sheet number information and the per-user upper-limit sheet number information are stored in the sheet-number storage section 112b on a category-by-category basis. For example, the category 1 corresponds to an image processing function when the complex machine 1 serves as a copy machine for color copying, and the category 4 corresponds to an image processing function when the complex machine 1 serves as a network printer for monochrome (black-and-white, in this embodiment) printing.

As shown in FIG. 8A, it is firstly determined into which of the categories illustrated in FIG. 8B the job executed in Step S119 illustrated in FIG. 6 is classified (Step S301). Then, the sum of the accumulated sheet number and the processed sheet number image-processed in Step S117, which are classified into the category determined in Step S301, is stored in the sheet-number storage section 112b as a new accumulated sheet number corresponding to the category determined in Step S301 (Step S303), and the sheet-number renew operation is completed.

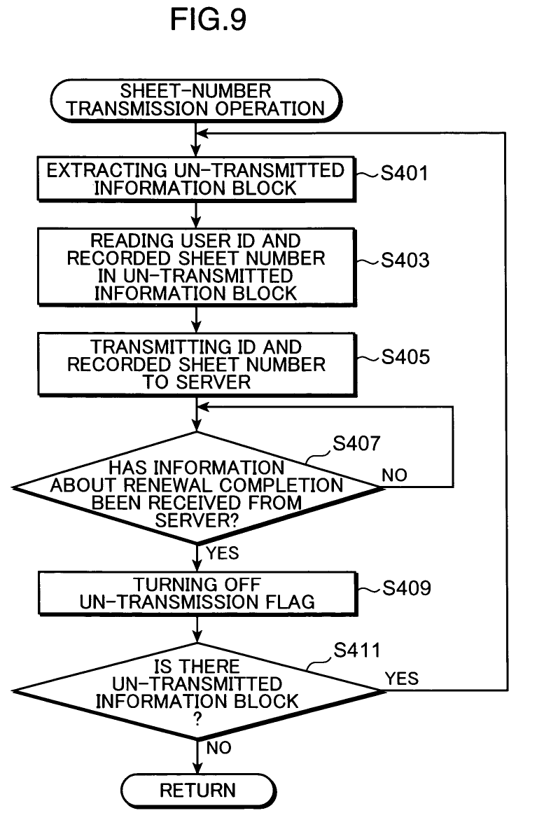

FIG. 9 is a detailed flowchart showing the sheet-number transmission operation to be executed in Step S127 in the flowchart illustrated in FIG. 6. The following operation is entirely performed by the sheet-number transmission section 111g. Firstly, with reference to the un-transmission flag 660 (Step S401) in each of the plurality of information blocks stored in the sheet-number storage section 112b as shown in FIG. 5, an information block of one user which has not been transmitted to the server apparatus 5 (hereinafter referred to as “un-transmitted information block”) is extracted therefrom. Then, a user ID 610 and a processed sheet number 640 in the extracted un-transmitted information block of the user are transmitted to the server apparatus 5 (Step S405).

Then, it is determined whether information about completion of renew has been received (Step S407). If it is determined that the information has not been received (NO in Step S407), the process will be kept in a standby state. When it is determined that the information has been received (YES in Step S407), the un-transmission flag 660 corresponding to the user ID 610 transmitted in Step 405 is turned off, and the corresponding processed sheet number 640 is reset to a zero value (Step S409). Then, it is determined whether another un-transmitted information block remains in the sheet-number storage section 112b (Step S411) When it is determined that another un-transmitted information block remains (YES in Step S411), the process returns to Step S401 to extract an un-transmitted information block of another user, and the operations of Step S403 and subsequent steps will be repeated. If it is determined that no un-transmitted information block remains (NO in Step S411), the process will be terminated.

As above, when the communication with the server device 5 is determined to be impossible, the processed-sheet-number information is stored in sheet-number storage section 112b in correspondence with the user ID 610. Thus, even if one or more image processing are executed during a period where it is impossible to communicate with the server apparatus 5, a processed sheet number 640 in each of the image processings is stored in the sheet-number storage section 112b in correspondence with the user ID without being cleared. Then, when the communication with the server device 5 is determined to be possible, the processed sheet number 640 stored in the sheet-number storage section 112b is transmitted to the server apparatus 5 in correspondence with the user ID. Therefore, processed-sheet-number information generated during a period where it is impossible to communicate with the server apparatus is stored in the sheet-number storage in correspondence with the user-identification information. Then, when the communication with the server apparatus is determined to be possible, the processed-sheet-number information stored in the sheet-number storage is transmitted to the server apparatus in correspondence with the user-identification information. Thus, the user ID 610 and the processed sheet number 640 generated during the period where it is impossible to communicate with the server apparatus 5 will become usable in the server apparatus 5. This makes it possible to reliably manage the accumulated sheet number which is an accumulated value of the number of image-processed sheets, on a user-by-used basis.

Further, it is determined whether a sum of an accumulated sheet number 630 acquired from the server apparatus 5 and an externally designated sheet number subject to an image processing is greater than the per-user upper-limit sheet number 620. When it is determined whether the sum is greater than the per-user upper-limit sheet number 620, an execution of the image processing accepted by the job execution section 111e is prohibited to prevent the sum from exceeding the per-user upper-limit sheet number 620. Thus, the reduction in cost, such as copying cost, can be facilitated by adequately setting the per-user upper-limit sheet number 620.

When it is determined that the communication with the server device 5 is impossible and the user ID is not stored in the sheet-number storage section 112b, an execution of the image processing accepted by the job execution section 111e is prohibited. This makes it possible to reliably prohibit the image processing system from being used by a user whose user ID 610 (i.e. per-user upper-limit sheet number 620) is not stored in the sheet-number storage section 112b.

That is, the management of the accumulated sheet number 630 cannot be applied to a user whose user ID 610 is not stored in the sheet-number storage section 112b, and therefore the use of the image processing system is prohibited to prevent an accumulated sheet number from exceeding the per-user upper-limit sheet number 620.

The above embodiment of the present invention may be variously changed and modified, for example, as follows.

(A) While the above embodiment has been described based on one example where an image processing apparatus is the complex machine 1 having all functions of a copy machine, a scanner, a facsimile machine, an Internet facsimile machine and a network printer, the present invention may be applied to an image processing apparatus having at least one of the functions of a copy machine, a facsimile machine, an Internet facsimile machine and a network printer.

(B) While the above embodiment has been described based on one example where the sheet-number storage section 112b is adapted to store the accumulated sheet number 630 and the processed sheet number 640, the present invention may be applied to an image processing apparatus comprising a sheet-number storage section 112b adapted to store either one of the accumulated sheet number 630 and the processed sheet number 640. In thus case, a capacity of the sheet-number storage section 112b can be reduced, and a processing in the sheet-number processing section 111f and the sheet-number transmission section 111g can be simplified. In addition, the server apparatus 5 is allowed to renew only the accumulated sheet number 630 in the sheet-number storage section 512a. In this case, processed-sheet-number information can be substantially managed in the complex machine 1 and the server apparatus 5, as with the above embodiment.

(C) While the above embodiment has been described based on one example where the possibility of communication with the server apparatus 5 is determined using the ping, any other suitable technique may be used for determining the possibility of communication with the server apparatus 5. For example, the possibility of the communication may be determined based on whether a communication line for communicating with the server apparatus 5 is normally connected to the complex machine 1. In this case, the possibility of the communication can be determined in a simplified manner.

(D) While the above embodiment has been described based on one example where the communication-possibility determination section 111b is designed to determine the possibility of communication with the server apparatus 5, at timings before and after an execution of a job, the possibility of communication with the server apparatus 5 may be determined at any other suitable timing. For example, the possibility of the communication may be determined at given time interval (e.g. every one second).

(E) While the above embodiment has been described based on one example where the prohibition section 111d is designed to determine whether a sum of the accumulated sheet number stored in the sheet-number storage section 112b and the designated sheet number accepted by the job execution section 111e is greater than the per-user upper-limit sheet number, the prohibition section llld is designed to determine whether the sum is greater than a predetermined upper-limit sheet number.

For example, the predetermined upper-limit sheet number may be set at given time intervals, for example, every one month, uniformly for all users. In this case, the entire processing can be simplified. When the upper-limit sheet number in each month is set uniformly, the server apparatus 5 may be designed to have a calendar function with calendar data so as to automatically set the upper-limit sheet number at the beginning of each month.

(F) While the above embodiment has been described based on one example where the sheet-number storage section 112b is designed to store the accumulated sheet number 630 and the per-user upper-limit sheet number 620 in such a manner as to be classified based on the eight categories, the number of categories is not limited to eight, but may be an appropriate number of one or more. For example, the number of categories may be determined depending on the number of functions of the complex machine.

(G) The above embodiment has been described based on one example where the prohibition section 111d is designed to determine whether a sum of the accumulated sheet number stored in the sheet-number storage section 112b and the designated sheet number accepted by the job execution section 111e is greater than the per-user upper-limit sheet number. For example, in the complex machine 1, when a scanner section 12 is designed to scan a plurality of documents while placing the documents on a contact glass one-by-one, it may be necessary to allow a user to pre-enter the number of sheets to be image-processed, as a designated sheet number, during copying. In contrast, when the scanner section 12 is designed to place any plural number of documents on the contact glass, it is not always necessary to allow a user to enter a pre-counted designated sheet number (the number of sheets to be placed on the contact glass). Specifically, this type of scanner section 12 is formed as an automatic document feeder having a feeding line for feeding a plurality of documents placed on a document tray from the uppermost or lowermost document one-by-one, carrying each document to a document reading position, and carrying the document after a reading operation out of the document reading position to a given position. Thus, a document sensor, such as a mechanical switch having movable arm adapted to come into contact with the document during feeding, or a photosensor adapted to emit light onto a surface of the document and detect the intensity of reflected light may be disposed at an appropriate position along the feeding line to sequentially add and accumulate a pulse-like detection signal per document from the sensor so as to receive information about the number of documents (the number of image-processed sheets).

Thus, during copying of a plurality of documents, the job execution section 111e may be designed to check or detect an execution of an image processing to each document to accumulate the number of image-processed documents as a processed sheet number, and the prohibition section 11d may be designed to determine whether a sum of the accumulated sheet number and the processed sheet number is greater than the predetermined upper-limit sheet number, and prohibit the processing when the processed sheet number becomes greater than the predetermined upper-limit sheet number. This also makes it possible to limit the processed sheet number within the upper-limit sheet number. Instead of the document sensor, a sensor capable of counting the number of recording sheets processed to have a document image transferred thereon may be disposed at an appropriates position to obtain a pulse-like detection signal in the same manner as that in the above document sensor, or the number of image-processed sheets may be counted based on the number of image forming operations in the printer 13. In this case, the present invention may be applied to a network printer.

(H) The above embodiment has been described based on one example where the prohibition section 111d is designed to determine whether a sum of the accumulated sheet number stored in the sheet-number storage section 112b and the designated sheet number accepted by the job execution section 111e is greater than the per-user upper-limit sheet number. However, when the complex machine 1 serves as an Internet facsimile machine, an undesirable situation occurs if a communication (transmission, receiving) function is discontinued by reason that a processed sheet number reaches the predetermined upper-limit sheet number during the communication, or if a print-out function is discontinued while maintaining a receiving function, when a processed sheet number reaches the predetermined upper-limit sheet number, or if, the above automatic document feeder of the scanner section 12a is precluded from carrying a transmission-target document to a document reading position during transmission when a processed sheet number reaches the predetermined upper-limit sheet number. Thus, in Internet facsimile communication for a plurality documents, a the job execution section 111e may be designed to acquire information about the number of image-processed documents (the number of documents read by the scanner section 12 during transmission; the number of sheets printed by the printer 13 during receiving) every time an image processing is executed to each document, and accumulate the acquired sheet number as a processed sheet number. Further, the prohibition section 111d may be designed to determine whether a sum of the accumulated sheet number and the processed sheet number is greater than the predetermined upper-limit sheet number, every time the image processing is executed. Specifically, the prohibition section 111d may be operable, if the sum is determined to be greater than the predetermined upper-limit sheet number during initiation of the transmission/receiving, to prohibit the initiation of the entire processing including the communication, and, if the sum is determined to be equal to or less than the predetermined upper-limit sheet number during initiation of the transmission/receiving, and it is determined that the sum becomes greater than the predetermined upper-limit sheet number during the processing, to postpone the prohibition against an execution of the processing until completion of the communication. This makes it possible to prevent the occurrence of undesirable situations, such as discontinuation of document reading during transmission or discontinuation of printing during receiving, and eliminate the risk of incorrect communications.

As described in the above embodiment and the modifications (G) and (H), the job execution section 111e may be designed to serve as processing acceptor operable to accept execution-sheet-number-related information about the number of sheets to be image-processed in response to an instruction for an execution of the image processing, and the prohibition section 111d may be designed to serve as prohibitor operable to determine whether a sum of the accumulated sheet number and a sheet number represented by the execution-sheet-number-related information is greater than the predetermined upper-limit sheet number, and, when the sum is determined to be greater than the predetermined upper-limit sheet number, to prohibit an execution of the image processing.

As described above, the present invention provides an image processing apparatus communicatably connected to a server apparatus for managing an accumulated sheet number which is an accumulated value of the number of image-processed sheets, and adapted to execute a given image processing. The image processing apparatus comprises: a user entry accepter for accepting user-identification information for identifying each user; a sheet-number storage adapted to store processed-sheet-number information representing the number of image-processed sheets, in correspondence with the user-identification information; a sheet-number processor for allowing the processed-sheet-number information to be stored in the sheet-number storage in correspondence with the user-identification information; a communication determinator for determining whether it is possible to communicate with the server apparatus; and a sheet-number transmitter operable, when the communication with the server apparatus is determined to be possible, to transmit the processed-sheet-number information stored in the sheet-number storage, to the server apparatus in correspondence with the user-identification information.

In the image processing apparatus, the user entry accepter is operable to accept the user-identification information for identifying each user, and the communication determinator is operable to determine whether it is possible to communicate with the server apparatus. Further, the sheet-number processor is operable to store the processed-sheet-number information representing the number of image-processed sheets in the sheet-number storage in correspondence with the user-identification information. Then, the sheet-number transmitter is operable, when the communication with the server apparatus is determined to be impossible, to allow the processed-sheet-number information to be kept in the state of being stored in the sheet-number storage in correspondence with the user-identification information, and, when the communication with the server apparatus is determined to be possible, to transmit the processed-sheet-number information stored in the sheet-number storage, to the server apparatus in correspondence with the user-identification information.

As above, when the communication with the server apparatus is determined to be impossible, for example, temporarily, the processed-sheet-number information is stored in the sheet-number storage in correspondence with the user-identification information. Thus, processed-sheet-number information generated during a period where it is impossible to communicate with the server apparatus is stored in the sheet-number storage in correspondence with the user-identification information. Then, after recovery of a communication function, when the communication with the server apparatus is determined to be possible, the processed-sheet-number information stored in the sheet-number storage is transmitted to the server apparatus in correspondence with the user-identification information. Thus, the processed-sheet-number information generated during a period where it is impossible to communicate with the server apparatus will become usable in the server apparatus after recovery of the communication function. This makes it possible to reliably manage the accumulated sheet number which is an accumulated value of the number of image-processed sheets, on a user-by-used basis.

Preferably, the image processing apparatus includes: a sheet-number acquisitor operable, when the communication determinator determines that it is possible to communicate with the server apparatus, to acquire information about the accumulated sheet number corresponding to the user-identification information, from the server apparatus, and store the acquired information in the sheet-number storage in correspondence with the user-identification information; processing acceptor operable to accept execution-sheet-number-related information about the number of sheets to be image-processed in response to an instruction for an execution of the image processing; and prohibitor operable to determine whether a sum of the accumulated sheet number and a sheet number represented by the execution-sheet-number-related information is greater than a predetermined upper-limit sheet number, and, when the sum is determined to be greater than the predetermined upper-limit sheet number, to prohibit an execution of the image processing.

In this image processing apparatus, the sheet-number acquisitor acquires the accumulated sheet number information corresponding to the user-identification information, from the server apparatus, and stores the acquired information in the sheet-number storage in correspondence with the user-identification information. Then, the processing acceptor accepts the execution-sheet-number-related information about the number of sheets to be image-processed in response to an instruction for an execution of the image processing. Further, the prohibitor determines whether a sum of the accumulated sheet number and the sheet number represented by the execution-sheet-number-related information is greater than the predetermined upper-limit sheet number, and prohibits an execution of the image processing when the sum is determined to be greater than the predetermined upper-limit sheet number.

As above, it is determined whether a sum of the accumulated sheet number acquired from the server apparatus and the sheet number represented by the execution-sheet-number-related information is greater than the predetermined upper-limit sheet number, and, when the sum is determined to be greater than the predetermined upper-limit sheet number, to prohibit an execution of the image processing. This makes it possible to prevent the image processing from executed in a sheet number exceeding the predetermined upper-limit sheet number. Thus, the reduction in cost, such as copying cost, can be facilitated by adequately setting the predetermined upper-limit sheet number.

As to the above processing acceptor and the prohibitor, in consideration of a situation where an execution of the image processing is instructed under the condition that the number of sheets for the image processing is known in advance, the processing acceptor may be designed to accept an external instruction for an execution of the image processing including at least a designated sheet number representing the number of sheets designated to be image-processed, and the prohibitor may be designed to determine whether a sum of the accumulated sheet number and the designated sheet number is greater than the predetermined upper-limit sheet number, and to prohibit an execution of the image processing for the designated number of sheets accepted by the processing acceptor, when the sum is determined to be greater than the predetermined upper-limit sheet number. Particularly when a function of copying a plurality of documents is performed using an automatic document feeder, the number of documents set to a document tray is not counting in advance of copying. Considering this case, the job execution section may be designed to check or detect an execution of an image processing to each of a plurality of documents during copying to accumulate the number of image-processed documents as a processed sheet number, and the prohibition section may be designed to determine whether a sum of the accumulated sheet number and the processed sheet number is greater than the predetermined upper-limit sheet number, and prohibit the processing when the processed sheet number becomes greater than the predetermined upper-limit sheet number. Further, in an Intermit facsimile communication, considering the undesirable situations caused by discontinuing to print out in the middle of receiving a given number of sheets, or discontinuing to transmit in the middle of transmitting a given number of sheets (e.g. in an automatic document feeder during transmission, an operation for carrying a plurality of documents to a document reading position is discontinued halfway without carrying a certain number of documents), the job execution section may be designed to check or detect an execution of the image processing to each of a plurality of documents during communication using an Intermit facsimile machine to accumulate the checked number as a processed sheet number, and the prohibition section may be designed to determine whether a sum of the accumulated sheet number and the processed sheet number is greater than the predetermined upper-limit sheet number. Specifically, the prohibition section may be operable, if the sum is determined to be greater than the predetermined upper-limit sheet number during initiation of the transmission/receiving, to prohibit the initiation of the entire processing, and, if the sum is determined to be equal to or less than the predetermined upper-limit sheet number during initiation of the transmission/receiving, and it is determined that the sum becomes greater than the predetermined upper-limit sheet number during the processing, to postpone the prohibition against an execution of the processing until completion of the communication.

Preferably, in the image processing apparatus, the server apparatus has per-user upper-limit-sheet-number information representing an upper limit value of the accumulated sheet number which is pre-set with respect to each user-identification information as the basis for permitting an execution of the image processing. Further, the sheet-number acquisitor is operable to acquire the per-user upper-limit-sheet-number information corresponding to the user-identification information, from the server apparatus, and store the acquired per-user upper-limit-sheet-number information in the sheet-number storage in correspondence with the user-identification information, and the prohibitor is operable to use the per-user upper-limit-sheet-number information as the predetermined upper-limit sheet number.

In this image processing apparatus, the per-user upper-limit-sheet-number information representing an upper limit value of the accumulated sheet number which is pre-set with respect to each user-identification information as the basis for permitting an execution of the image processing is held in the server apparatus. Then, the sheet-number acquisitor acquires the per-user upper-limit-sheet-number information corresponding to the user-identification information, from the server apparatus, and stores the acquired per-user upper-limit-sheet-number information in the sheet-number storage in correspondence with the user-identification information. Further, the prohibitor uses the per-user upper-limit-sheet-number information as the predetermined upper-limit sheet number.

Thus, the per-user upper-limit-sheet-number information corresponding to each user-identification information and representing an upper limit value of the accumulated sheet number as the basis for permitting an execution of the image processing is used as the predetermined upper-limit sheet number. This makes it possible to provide an adequate upper-limit sheet number for use as an upper limit value of the accumulated sheet number.

Preferably, in the image processing apparatus, the prohibitor is operable, when the communication with the server apparatus is determined to be impossible, to determine whether the user-identification information is stored in the sheet-number storage, and, if the user-identification information is not stored, to prohibit an execution of the image processing accepted by the processing acceptor.

In this image processing apparatus, when the communication with the server apparatus is determined to be impossible, the prohibitor determines whether the user-identification information is stored in the sheet-number storage, and prohibits an execution of the image processing accepted by the processing acceptor if the user-identification information is not stored.

Thus, when the communication with the server apparatus is determined to be impossible, and it is determined that the user-identification information is stored in the sheet-number storage, an execution of the image processing accepted by the processing acceptor is prohibited. This makes it possible to reliably prohibit the image processing system from being used by a user whose user-identification information (i.e. per-user upper-limit sheet number information) is not stored in the sheet-number storage.

That is, the management of the accumulated sheet number cannot be applied to a user whose user-identification information is not stored in the sheet-number storage, and therefore the use of the image processing system can be reliably prohibited to prevent an accumulated sheet number from exceeding the upper-limit sheet number.

Preferably, in the image processing apparatus, the sheet-number storage is designed to have a plurality of storage areas classified based on respective image processing functions, and the sheet-number processor is operable to store the processed-sheet-number information representing the number of sheets image-processed according to each of the image processing functions, in the corresponding storage area in correspondence with the user-identification information.

In this image processing apparatus, the sheet-number storage has a plurality of storage areas classified based on respective image processing functions, and the sheet-number processor stores the processed-sheet-number information representing the number of sheets image-processed according to each of the image processing functions, in the corresponding storage area in correspondence with the user-identification information. Thus, when the image processing apparatus in the complex machine performs a plurality of functions, the processed sheet number for each function can be managed.

The present invention also provides an image processing system comprising: an image processing apparatus designed to execute a function of at least one selected from the group consisting of a copy machine, a scanner, a facsimile machine, an Internet facsimile machine and a network printer; and a server apparatus communicatably connected to the image processing apparatus. In this image processing system, the image processing apparatus includes: a user entry accepter for accepting user-identification information for identifying each user; a sheet-number storage adapted to store processed-sheet-number information representing the number of image-processed sheets, in correspondence with the user-identification information; a sheet-number processor for allowing the processed-sheet-number information to be stored in the sheet-number storage in correspondence with the user-identification information; a communication determinator for determining whether it is possible to communicate with the server apparatus; and a sheet-number transmitter operable, when the communication with the server apparatus is determined to be possible, to transmit the processed-sheet-number information stored in the sheet-number storage, to the server apparatus in correspondence with the user-identification information. The server apparatus includes: a sheet-number storage for storing accumulated sheet number information representing an accumulated value of the number of sheets image-processed in the image processing apparatus, in correspondence with the user-identification information; and a sheet-number renewer operable, in response to receiving the user-identification information and the processed-sheet-number information, to renew the stored accumulated sheet number corresponding to the received user-identification information, to a sum of the stored accumulated sheet number and the received processed-sheet-number.

In the image processing apparatus of this image processing system, the user entry accepter accepts the user-identification information for identifying each user, and the communication determinator determines whether it is possible to communicate with the server apparatus. Further, the sheet-number storage stores the processed-sheet-number information representing the number of image-processed sheets, in correspondence with the user-identification information. Then, when the communication with the server apparatus is determined to be impossible, the sheet-number processor stores the processed-sheet-number information in the sheet-number storage in correspondence with the user-identification information. When the communication with the server apparatus is determined to be possible, the sheet-number transmitter transmits the processed-sheet-number information stored in the sheet-number storage, to the server apparatus in correspondence with the user-identification information.

In the server apparatus, the sheet-number storage stores the accumulated sheet number information representing an accumulated value of the number of sheets image-processed in the image processing apparatus, in correspondence with the user-identification information. Further, in response to receiving the user-identification information and the processed-sheet-number information from the image processing apparatus, the sheet-number renewer renews the stored accumulated sheet number corresponding to the received user-identification information, to a sum of the stored accumulated sheet number and the received processed-sheet-number.

As above, when the communication with the server apparatus is determined to be impossible, for example, temporarily, the processed-sheet-number information is stored in the sheet-number storage in correspondence with the user-identification information. Thus, processed-sheet-number information generated during a period where it is impossible to communicate with the server apparatus is stored in the sheet-number storage in correspondence with the user-identification information. Then, after recovery of a communication function, when the communication with the server apparatus is determined to be possible, the processed-sheet-number information stored in the sheet-number storage is transmitted to the server apparatus in correspondence with the user-identification information. Then, in the server apparatus, the accumulated sheet number corresponding to the received user-identification information which is stored in the sheet-number storage, is renewed to a sum of the stored accumulated sheet number and the received processed-sheet-number. Thus, the user-identification information and the processed-sheet-number information generated during a period where it is impossible to communicate with the server apparatus will become usable in the server apparatus after recovery of the communication function. This makes it possible to reliably manage the accumulated sheet number which is an accumulated value of the number of image-processed sheets, on a user-by-used basis.

This application is based on patent application No. 2005-197020 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image processing apparatus communicatably connected to a server apparatus for managing an accumulated sheet number which is an accumulated value of the number of image-processed sheets, and adapted to execute an image processing, comprising:
a user entry accepter for accepting user-identification information for identifying each user;
a sheet-number storage adapted to store processed-sheet-number information representing the number of image-processed sheets, in correspondence with the user-identification information;
a sheet-number processor for allowing the processed-sheet-number information to be stored in the sheet-number storage in correspondence with the user-identification information;
a communication determinator for determining whether it is possible to communicate with the server apparatus; and
a sheet-number transmitter operable, when the communication with the server apparatus is determined to be possible, to transmit the processed-sheet-number information stored in the sheet-number storage, to the server apparatus in correspondence with the user-identification information.

2. The image processing apparatus as defined in claim 1, which includes:
a sheet-number acquisitor operable, when the communication with the server apparatus is determined to be possible, to acquire information about the accumulated sheet number corresponding to the user-identification information, from the server apparatus, and store the acquired information in the sheet-number storage in correspondence with the user-identification information;
a processing acceptor operable to accept execution-sheet-number-related information about the number of sheets to be image-processed in response to an instruction for an execution of the image processing; and
a prohibitor operable to determine whether a sum of the accumulated sheet number and a sheet number represented by the execution-sheet-number-related information is greater than a predetermined upper-limit sheet number, and, when the sum is determined to be greater than the predetermined upper-limit sheet number, to prohibit an execution of the image processing.

3. The image processing apparatus as defined in claim 2, wherein:
the server apparatus has per-user upper-limit-sheet-number information representing an upper limit value of the accumulated sheet number which is pre-set with respect to each user-identification information as the basis for permitting an execution of the image processing;
the sheet-number acquisitor is operable to acquire the per-user upper-limit-sheet-number information corresponding to the user-identification information, from the server apparatus, and store the acquired per-user upper-limit-sheet-number information in the sheet-number storage in correspondence with the user-identification information; and
the prohibitor is operable to use the per-user upper-limit-sheet-number information as the predetermined upper-limit sheet number.

4. The image processing apparatus as defined in claim 3, wherein the prohibitor is operable, when the communication with the server apparatus is determined to be impossible, to determine whether the user-identification information is stored in the sheet-number storage, and, if the user-identification information is not stored, to prohibit an execution of the image processing accepted by the processing acceptor.

5. The image processing apparatus as defined in claim 2, wherein the prohibitor is operable, when the communication with the server apparatus is determined to be impossible, to determine whether the user-identification information is stored in the sheet-number storage, and, if the user-identification information is not stored, to prohibit an execution of the image processing accepted by the processing acceptor.

6. The image processing apparatus as defined in claim 1, wherein:
the sheet-number storage is designed to have a plurality of storage areas classified based on respective image processing functions; and
the sheet-number processor is operable to store the processed-sheet-number information representing the number of sheets image-processed according to each of the image processing functions, in the corresponding storage area in correspondence with the user-identification information.

7. An image processing system comprising:
an image processing apparatus designed to execute a function of at least one selected from the group consisting of a copy machine, a scanner, a facsimile machine, an Internet facsimile machine and a network printer; and
a server apparatus communicatably connected to the image processing apparatus,
wherein the image processing apparatus includes:
a user entry accepter for accepting user-identification information for identifying each user;
a sheet-number storage adapted to store processed-sheet-number information representing the number of image-processed sheets, in correspondence with the user-identification information;
a sheet-number processor for allowing the processed-sheet-number information to be stored in the sheet-number storage in correspondence with the user-identification information;
a communication determinator for determining whether it is possible to communicate with the server apparatus; and
a sheet-number transmitter operable, when the communication with the server apparatus is determined to be possible, to transmit the processed-sheet-number information stored in the sheet-number storage, to the server apparatus in correspondence with the user-identification information, and
the server apparatus includes:
a sheet-number storage for storing accumulated sheet number information representing an accumulated value of the number of sheets image-processed in the image processing apparatus, in correspondence with the user-identification information; and
a sheet-number renewer operable, in response to receiving the user-identification information and the processed-sheet-number information from the image processing apparatus, to renew the stored accumulated sheet number corresponding to the received user-identification information, to a sum of the stored accumulated sheet number and the received processed-sheet-number.
